(19) United States
(12) Patent Application Publication
(10) Pub. No.: US 2002/0156722 A1
(43) Pub. Date: Oct. 24, 2002

(54) Automated securities trading system

(76) Inventor: Ken M. Greenwood, Westminster, MD (US)

Correspondence Address: Andrew C. Aitken, VENABLE, BAETJER, HOWARD &, CIVILETTI, LLP, Post Office Box 34385, Washington, DC, 20043-9998, US

(21) Appl. No.: 10/102,206

(22) Filed: Mar. 21, 2002

Related U.S. Application Data
(60) Provisional application No. 60/277,257, filed on Mar. 21, 2001.

(51) Int. Cl. G06F 17/60

(52) U.S. Cl. 705/37

(57) ABSTRACT

A method for the automated trading of securities, a computer system for carrying out the method, and computer software product containing logic for carrying out the method are disclosed. The system and method integrate information acquired from an investment advice system about a security and places trades with a brokerage system based on the acquired investment advice information. The parameters used to determine whether or not a specified security is to be traded can be a default parameter or a trading parameter specified by a user via a graphical user interface. The trading parameters set the constraints within which the information acquired from the investment advice system is analyzed.

The applicant of this patent application clams the benefit of the filing date of U.S. Provisional Application Serial No. 06/277,257 that was filed on Mar. 21, 2001.

### FIELD OF THE INVENTION

This invention relates to an automated trading system that is implemented on a computer network. Specifically, this invention relates to a computer system for the automated trading of securities where the automated system of the invention implements a connection between an investment advice system and a brokerage system and the advice acquired from the advice system may be automatically exploited to trade securities based upon predetermined user defined criteria.

### BACKGROUND OF THE INVENTION

Securities advice web sites are popular Internet services that allow users to obtain investment advice information. Such information comes in the form of trading “picks,” strategies, algorithms, and systems. Some existing programs issue textual “signals” to users advising them to trade a security at a given time. Being able to place orders through a brokerage firm via electronic messaging is an essential part of this process—it enables users to timely avail themselves of advice in a cost-efficient and independent manner and to timely implement the trades necessary to realize profit from the advice.

One example of such investment advice is the use of trading algorithms based upon market trends. There are a number of programs or systems that provide investment advice based upon predetermined algorithms. These various investment advice strategies typically use historical trading information (e.g., volume, price and volatility of a particular stock). Analyzing the behavior of any given stock and its visual representation in the form of patterns and trends on a graph is known in the securities trading arts as a “technical analysis.”

One example of a technical analysis is referred to as the Donchian Channels method developed by technical analyst Richard Donchian (Patel, C., Technical Trading Systems for Commodities and Stocks, Traders Press. (1998)). The Donchian Channels method tracks 5- and 20-day moving averages. This method involves plotting the highest high and lowest low price over a predetermined time period. In this regard, the futures industry widely uses 20-day low and high levels as support and resistance. A simple trading system based upon the Donchian Channels method is to buy a breakout above a 20-day high and sell short below a 20-day low. Five-day low and 5-day high levels are often used to stop long positions and short positions respectively. When such events occur, subscribers to an investment advice provided can be notified to trade stocks.

Other examples include (1) exponential moving averages; wherein a moving average gives weight to the latest data points (in a predetermined period), thereby responding more quickly to recent trends, (2) Moving average convergence-divergence; wherein a technical analysis indicator based on the interaction of a long-term moving average and a short-term moving average, consists of two lines. For example, in connection with the latter, a fast line is calculated by taking the difference between two moving averages and the slow line is determined by a smoothing (or rate of change) of the fast line. The crossover of the two lines may produce bullish and bearish trending signals. The “MACD” or Moving Average Convergence-Divergence is a trend indicator based on the interaction of a long-term moving average and a short-term moving average.

Regardless of the advice system used, the ability to place the trades timely, accurately and reliably is important to maximizing the profit potential of any of these investment systems. Often, the success of the investment system can depend not only on these factors, but also on the accurate tracking of the investments currently held. Obviously, as the amount of money that is invested increases, the importance of being able to timely and accurately make trades in response to investment advice also increases.

The present invention provides a system that automates the monitoring of an investment advice system and the securities under consideration. The system of the present invention also provides a timely mode to trade these securities and to optimize the profit potential and the return-on-investment.

### SUMMARY OF THE INVENTION

The invention provides a method and system for automating the trading of securities that

(1) acquires investment advice from the investment advice source,

(2) formulates the messages necessary to trade securities based on this advice, and

(3) transmits the messages to brokers for trade execution.

In one embodiment of the invention, the automated trading system increases the volume of trades a user is able to execute in a given time period, preferably within an eight hour period to optimize the system for day trading, thereby optimizing the amount of return from any given investment advice system.

In another embodiment, the automated trading system comprises a suite of computer programs that read investment advice, evaluate the investment advice based on the securities that a user already holds and the amount of capital available for further investing, and subsequently formulate trades, which are transmitted to a brokerage system for execution.

In the preferred embodiment, the system transmits information between the investment advice system and the brokerage system and the transmission is designed to occur over the Internet.

Herein, the provided system enables a user to enter and store configuration information that specifies trading parameters. These types of trading parameters entered determine the amount of risk the user is willing to tolerate, the amount of capital the user wishes the system to manage, and the user's identification information such as their brokerage account number and login IDs among the various systems integrated by the invention. In addition, the user can also set automation preferences, such as execution schedule and transmission medium connection information, or the user may rely on system defaults.

These aspects, advantages, and other salient features of the invention will become apparent from the annexed drawings and the following detailed description of the invention.

### BRIEF DESCRIPTION OF THE DRAWINGS

FIG. 1 depicts the major software components of the Automated Trading System and the major components it interfaces therewith.

FIG. 2 depicts the way data flows from system to system, showing the Automated Trading System as the central point of communication between the investment advice system and the broker.

FIG. 3 shows the major data components.

FIG. 4 shows major processes and the flow of control between them.

FIGS. 5A and 5B show the tables in the database of the automated trading system and their relationships.

FIG. 6 shows the login screen of the automated trading system, through which the user is authenticated.

FIG. 7 shows the “hotlist” screen of the automated trading system that shows the users the status of the portfolio.

FIG. 8 shows the trade screen of the automated trading system where the user performs trade functions.

FIG. 9 shows a flowchart depicting processing that occurs during a trading engine cycle.

FIG. 10 shows a flowchart depicting how orders are generated from the daily buy/sell lists.

FIG. 11 shows a flowchart depicting how relevant new transactions are processed.

FIG. 12 shows a flowchart depicting how the cross-band (x-band) orders are generated.

FIG. 13 shows the splash screen displayed to the user when the automated trading system is started.

### DESCRIPTION OF THE INVENTION

As used herein the terms “stock,” “security,” “stock holding,” or “position” shall be used interchangeably and are understood to mean the capital or fund that a corporation raises through the sale of shares entitling a stockholder to dividends and to other rights of ownership, such as voting rights; the number of shares that each stockholder possesses. Also encompassed within the meaning of these terms are stock certificates or fungible commodities such as ADR's that can be purchased or sold by a user, trader, day trader, individual, or corporation in order to increase (by purchasing) or decrease (by selling) the equity (measured by the number of shares of stock) owned in the company issuing the stock or security. The terms shall also encompass any and all meanings ascribed thereto by the Securities and Exchange Commission, the American Stock Exchange, the NASDAQ, the S&P 500, the New York Stock Exchange, any and all international exchanges (e.g., the FTSE, MONEP, MATIF, SWX, DAX, HKEX, Nikkei index, Tokyo Stock Exchange, or the like), the Wall Street Journal, or the Financial Times.

The system resides in the form of interrelated software logic components on the computer readable storage medium (e.g. hard disk drive, JAZ drive, RAID drive, or other computer readable storage medium) of a computer. The computer system can be either PC/Windows based [Intel, Cyrix, or AMG], Macintosh based [Motorola/PowerPC], or may be of any architecture known in the art that supports Unix operating environments (e.g., SunOs (with or without Solaris or Xwindows), Linux/SuSE/Caldera/other open source Unix [and their various graphical user interface flavors], SGI OS, System V, etc).

The computer is connected to the transmission medium, preferably a LAN, more preferably a WAN, and most preferably to the Internet. It is through the transmission medium that the system communicates and acquires information from the investment advice system and transmits formulated orders to the brokerage system.

In another exemplary embodiment, the stock-picks can be generated locally on the user's PC as well. Thus, the automated trading system of the invention can be implemented to integrate a user chosen “stock-pick” generation tool installed on their PC that does not necessarily rely on a continuous network connection.

The computer running the several software products of the invention can remain inactive (e.g., not in immediate communication with the transmission medium between the brokerage system or between the investment advice system). The system of the present invention can remain in this inactive state until the user manually requests that the system reconnect. Likewise, the system can remain inactive until a user specified automation parameter triggers a reconnection. Preferably, the system is in constant connection with the brokerage and investment advice systems by way of a transmission medium.

The invention can acquire investment advice information from an online source and feed it to a brokerage system is also online. Herein, the term, online means “immediately available,” accessible in real-time, “or immediately accessible.” For example, a system on the Internet that publishes stock-picks in HTML, XML, text, Microsoft Excel™ formats, or via email (e.g., text, HTML, or MIME) is an online system for the purposes of this invention. Exemplary investment advice systems are, for example, BuySellOrHold.com, Pitbull Investor, and StockTradingPicks.com.

The term “online” shall also mean a system on the user's PC or on another computer (not necessarily a PC) on an accessible LAN or WAN that generates picks and stores them on a hard disk drive (directly accessible or remotely accessible) in any format, or communicates them directly to the automated trading system of the invention via direct (API) calls. Examples of such investment advise systems are Indigo, Investor 3000, EarningScan Pro, and MarketWarrior. Manually downloaded picks from the Internet, or other source, stored on a computer readable storage medium (e.g., a hard disk drive) accessible (directly or indirectly) to the invention are also within the meaning of the term “online.” Additionally, users may pick their own stocks and store them on a computer readable storage medium accessible to the invention; these stock picks shall also be considered “online” within the meaning and scope of the invention.

With respect to the term “online” as used to describe brokerage systems herein, the term shall mean “immediately accessible” to the user's PC via an electronic communication medium such as the Internet, direct connection via telephone, connection via mobile phone, LAN, WAN, T1, T3, DSL, or X.25.

### The Several Components of the Automated Trading System

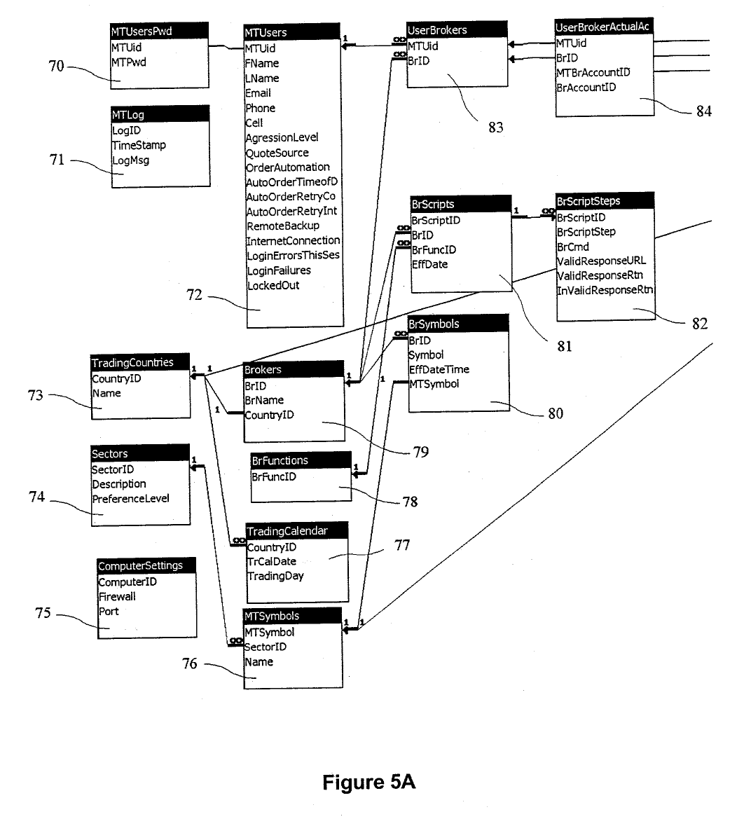

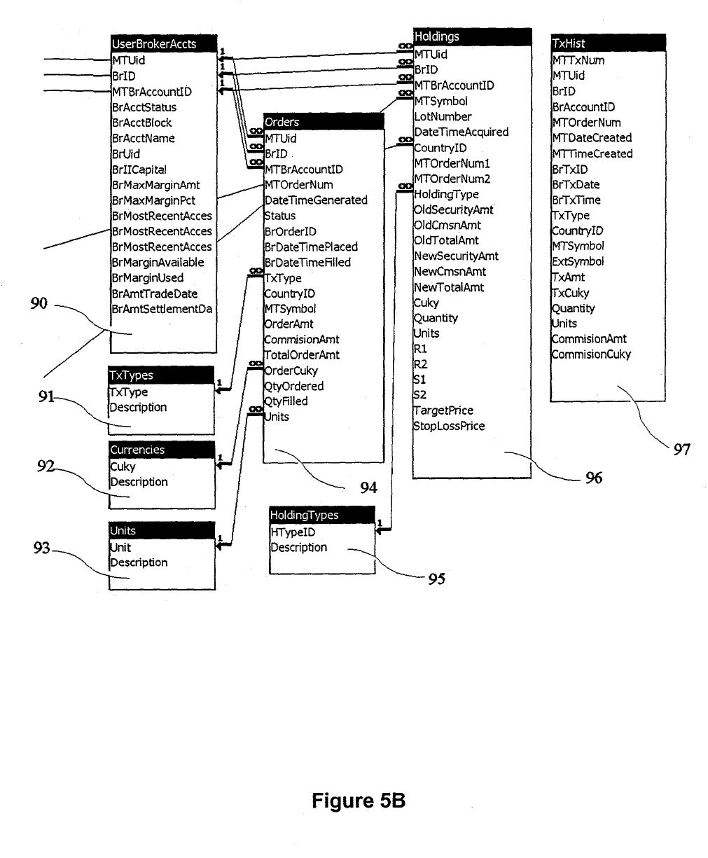

The automated trading system comprises a database for storing and retrieving the configuration information, securities order and tracking information, and the scripts needed to execute brokerage functions (FIG. 5A-5B). The database also stores and is integrated with means for retrieving a user's ID and password information.

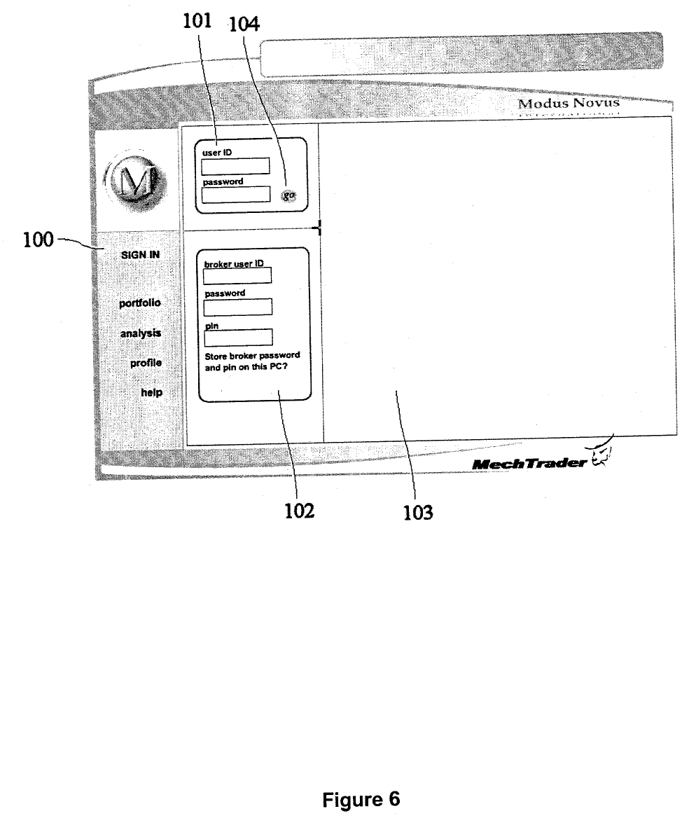

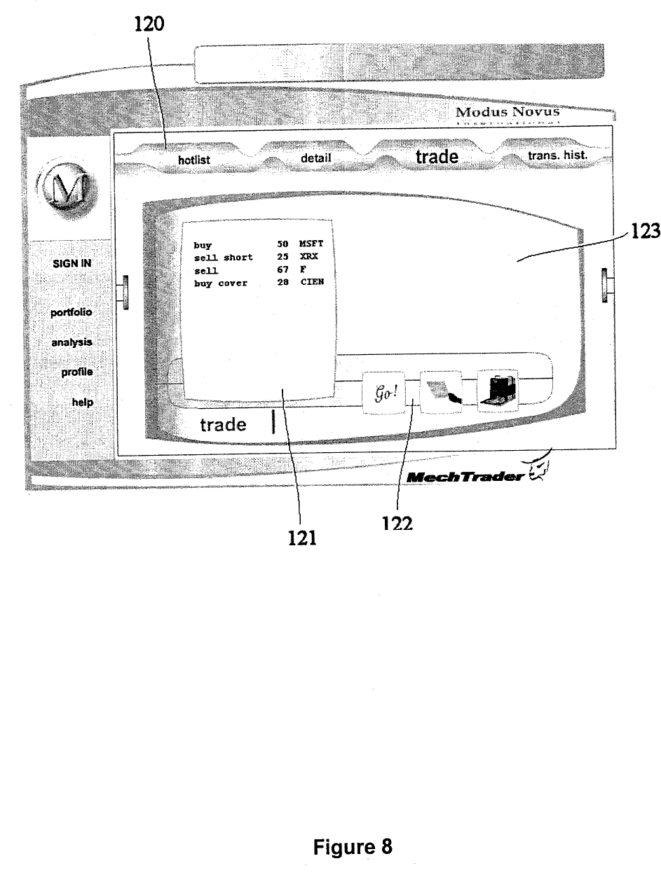

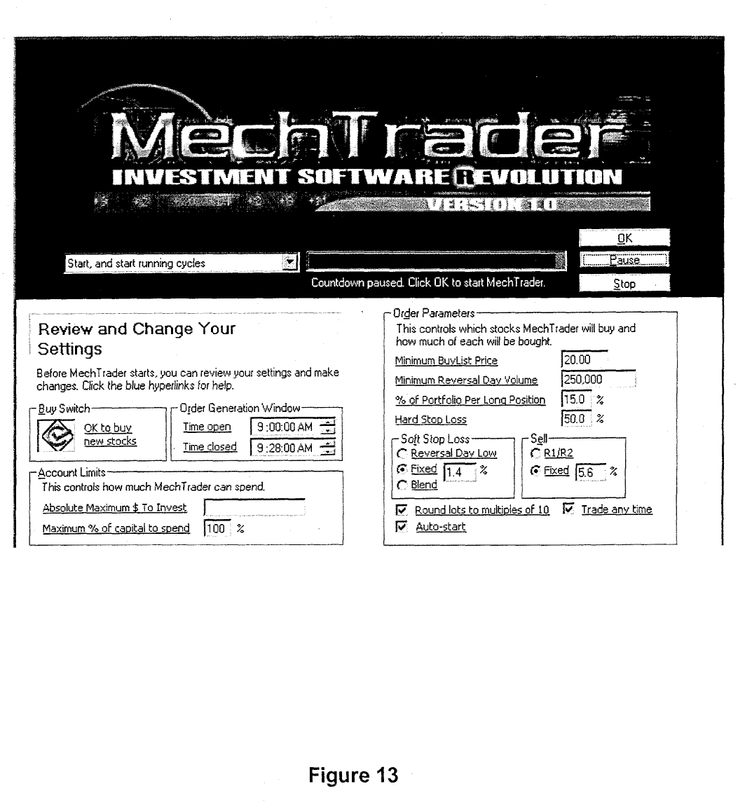

The user enters their personal information (FIG. 6), specifies trading parameters, and specifies automation parameters on one or more graphical user interfaces (FIG. 13). The graphical user interfaces also permit viewing (FIG. 8) the securities held and associated transaction information (e.g., time of trade, the number of shares traded, price, and brokerage account tracking information), and controlling and monitoring in general the activities of the system.

The automated trading system relies on a trading engine that contains the logic necessary to perform the functions required to implement the advice given by one or more investment advice systems. A database interface layer insulates the trade engine from the database location and protocol and an automation engine regulates the execution of the logic within the trade engine.

### Overview of the Automated Trading System

Upon startup of a host computer, the automation engine begins execution. Periodically, it triggers the execution of the trade engine, which, so started, reads information from it's own databases and also from the investment advice system and makes a determination whether a particular security on which advice has been obtained should be traded. If the system determines that no trades should take place, it ceases to operate until the next time it is summoned by the automation engine.

In addition, the user can invoke the functionality of the trade engine manually, at any time from the user interface.

Alternatively, if the trade engine determines that one or more trades should take place, it applies the information at hand to the logic necessary to implement the investment advice system and formulates orders to trade securities. The system then transmits the order to an online broker, for example an online broker such as Tdwaterhouse.com or Datek online via the Internet. Transmission packets can take the form of TCP/IP packets, packets that travel over the hypertext transfer protocol (HTTP) or its secured counterpart (HTTPS), Novell Network (IPX) packets, NetBUI, AppleTalk/LocalTalk, Ethernet, CSMA/CD (Ethernet), TDM, TDMA, (ALOHA), or any other data transmission protocols or data packet transmission protocols known in the art.

The system is preferably designed to confirm the execution of a trade based upon “feedback” from the online broker in the form of text based or binary-based confirmation that a trade has been executed successfully.

If the automated trading system needs to communicate to the investment advice system or to the online brokerage system via a transmission medium, which is at that time not available to it, and if the automated trading system has been configured to request that the transmission medium be made available to it, it would request a connection.

If the request for connection should fail, the system retries the request or tries alternate methods of communication (e.g., addresses different ports or channels) and at periodic intervals up to an optional maximum number of attempts, as configured. During order placement, the automated trading system receives confirmation from the broker of order acceptance, and stores such information in its database.

After placing each order, the system periodically (preferably every 2-5 minutes, more preferably every minute, or most preferably by the period specified by the user) sends messages to the online brokerage system requesting the status of each order. If an order is reported not to be found by the broker, the system of the invention follows up with subsequent queries at predetermined intervals in an attempt to determine the disposition of the order. If the automated trading system cannot determine the status of the order, it registers an error condition, which requires the user to follow up and investigate the status of the order manually.

If the order is found, as the order's status changes with the broker, the automated trading system reflects this change in status by periodically querying the brokerage system.

When the broker has filled the order and when the automated trading system has discovered this, it will, depending upon the procedures prescribed by the investment advice system, place one or more additional orders, the purpose of these orders being to realize gain should the security's value increase acceptably and prevent loss should the security's value degrade unacceptably.

During subsequent periodic monitoring of these orders, the system recognizes, if any of these orders have been cancelled, lost or whether the broker has caused the order to expire or otherwise made the order ineffective. Upon discovering such, it will submit another order to replace the previous one. In the event the trade is not executed within a predetermined time period, the system may stop the execution order based upon current market conditions. The current system is optimized for day trading wherein the preferred period for continuous operation is a period of about seven to about eight hours beginning about one-half hour prior to the start of trading on any given day to the end of trading on that day. The system continuously attempts to execute trades within the, about seven-hour time period.

During subsequent periodic processing of any such orders, the system will recognize when an order has been filled, and adjust the database and reporting mechanisms of the graphical user interface, accordingly. The system applies the newly gained capital to subsequent investments if so configured, or it adjusts its capitalization for subsequent trades. In either case, manual user configurations are within the scope of the invention and the system can be configured to adjust the investment strategies and/or its parameters to suit specific returns or losses encountered.

The automated trading system also reconciles the amounts reported by the broker with the amounts known to it and calculated by it, and reports any variance or discrepancies. The system can be shut off at any time, via a locally or remotely issued command or electronic signal or message (given the sender of the signal has appropriate authorization) if it is so configured.

The system can detect unacceptable conditions and to shut itself off, to prevent access to it, or to otherwise modify its' own behavior to mitigate damages during unfavorable circumstances. Examples of such circumstances: a) when significant losses are incurred, or b) when it detects an unsafe environment or a suspicious change in its environment or c) when it receive signals from the user interface or from other programs that might indicate that an unauthorized user is attempting to gain access to its information or to control or modify its signals or actions.

The system can “adopt” orders already placed and securities already owned by the user, so that it may, as far as possible, monitor them and trade them as it does the rest of its securities using the investment advice system procedures. The graphical user interface can also be configured to accept user input wherein the securities currently held by the user can be highlighted in various ways such as shades and/or colors, to thereby indicate various properties of the security, such as whether the security has gained or lost value, and how much value it has gained or lost.

With regards to security, there are two interrelated databases as shown by FIGS. 5A and 5B. The first contains the general trading information, and the second contains sensitive user-access information such as account numbers, User IDs, passwords, and PINs. This configuration enables the general trading data to be backed up remotely without also copying the sensitive User ID and password information.

### EXAMPLE I

### Detailed Structure of an Automated Trading System According to the Invention

Information and Data Flow

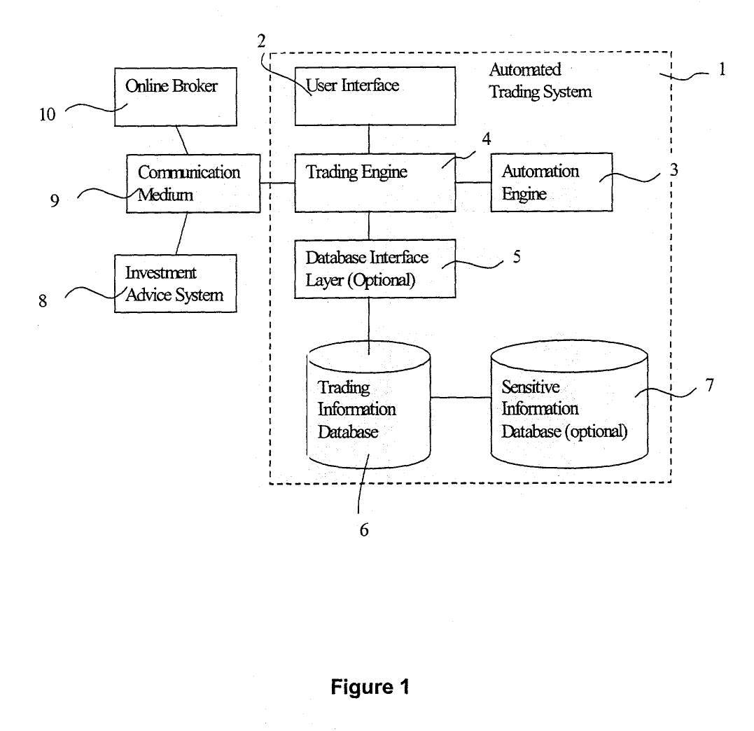

Referring now to FIG. 1, the user initiates the Automated Trading System 1 and Automation Engine 3, which shows to the user the User Interface 2, and starts the Trading Engine 4, and, through the Database Interface Layer 5, opens the Databases 6 and 7.

The user enters their user ID and password into the User Interface 2. The Trading Engine 4 passes a request through the Database Interface Layer 5 to retrieve that user ID's password from Sensitive Information Database 7. Trading Engine 4 compares the password entered by the user with that returned by the Database Interface Layer 5. If they match, the user is permitted to proceed. If there is no user ID-password match, or if the system fails to identify a user ID as one contained in the Sensitive Information Database 7, then the user is prevented from proceeding.

Once the user has entered the correct user ID and password, Trading Engine 4 sends a request to Database Interface Layer 5 to obtain the user's portfolio and current orders. Database Interface Layer 5 obtains the requested information from the Trading Information Database 6 and returns it to the Trading Engine 4, which displays it to the user via User Interface 2. Trading Engine 4 then connects through Communication Medium 9 to Online Broker 10 obtaining the latest status of the user's account and orders from Online Broker 10, updating this information in Trading Information Database 6 via Database Interface Layer 5 and displaying the updates via User Interface 2.

Trading Engine 4 then connects through Communication Medium 9 to Investment Advice System 8, obtaining the latest status of the user's account and orders from Online Broker 10, updating this information in Trading Information Database 6 via Database Interface Layer 5 and displaying the updates via User Interface 2.

Trading Engine 4 then uses the amount of funds available in the account with Online Broker 10, and the advice from Investment Advice System 8, and the user's preferences stored in Trading Information Database 6 to determine if any trades should occur. If trades should occur, Trading Engine 4 formulates orders and stores them in Trading Information Database 6.

The user then may display the recommended trades via User Interface 2, and optionally selects or deselects orders to be executed. The user then instructs Trading Engine 4 via User Interface 2 to place the orders with Online Broker 10. The Trading Engine then reads broker scripts from Trading Information Database 6 that give the Trading Engine 4 the precise sequence of steps to perform with Online Broker 10 and the expected responses. The Trading Engine 4 then submits the orders to Online Broker 10 via Communication Medium 9, updating the status of the orders in Trading Information Database 6 and displaying their status via User Interface 2.

In addition a user may manually initiate the Trading Engine 4. The Automation Engine 3 can also initiate the Trading Engine 4 at predetermined times to perform the functions as discussed above automatically, without user intervention.

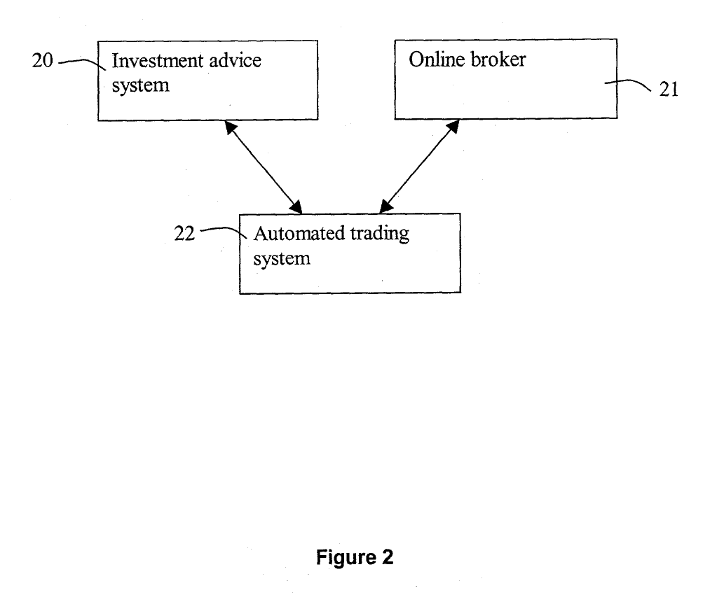

Turning now to FIG. 2, the Automated Trading System 22 is the central point of control between the Investment Advice System 20 and the Online Broker 21. The Automated Trading System 22 transmits information to each, and receives information from each.

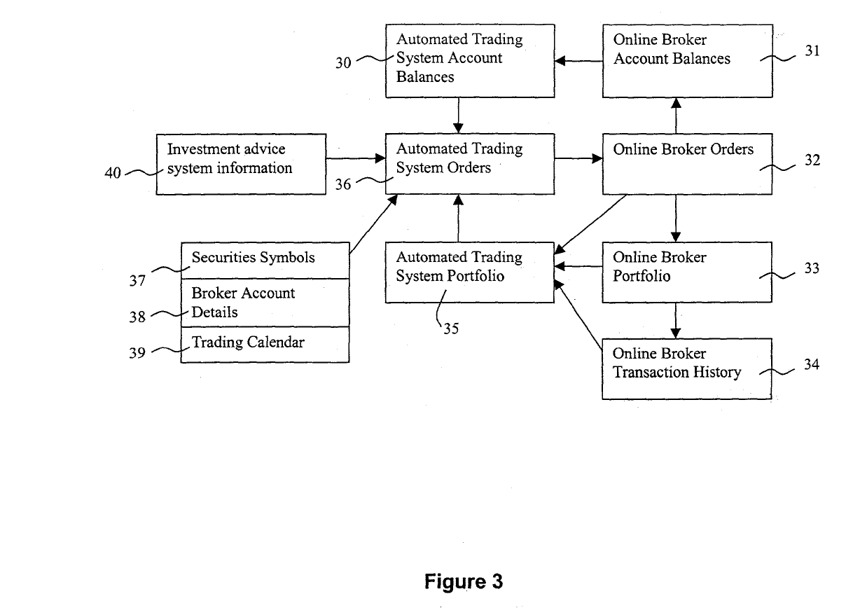

Turning now to FIG. 3, when Trading Engine 4 from FIG. 1 requires the creation of Automated Trading System Orders 36, it access the following information: Investment Advice System Information 40, Securities Symbols 37, Broker Account Details 38, Broker Scripts 39, Trading Calendar 39, Automated Trading System Portfolio 35 and the Automated Trading System Account Balances 30. The Automated Trading System Orders 36 are submitted to the online broker and become the Online Broker Orders 32. When the orders execute, the broker updates the Online Broker Account Balances 31, the Online Broker Portfolio 33 and the Online Broker Transaction History 34. The trading engine reads the Online Broker Account Balances 31 to update the Automated Trading System Account Balances 30. The trading engine also reads the Online Broker Orders 32, Online Broker Portfolio 33 and Online Broker Transaction History 34 to update the Automated Trading System Portfolio 35.

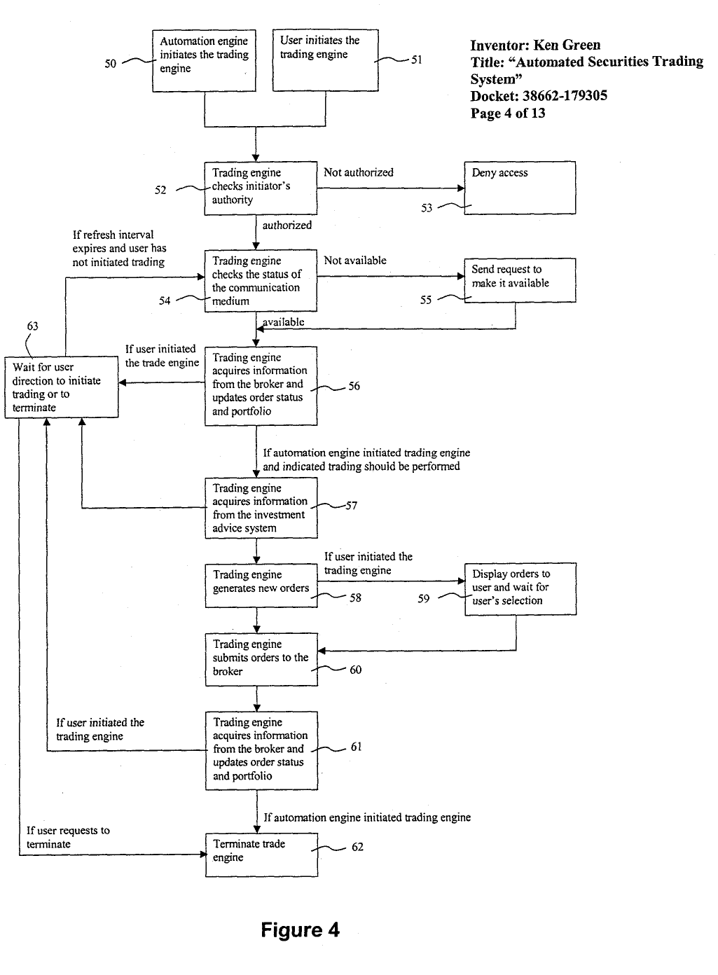

Turning now to FIG. 4, boxes 50 and 51 show that the Trading Engine 52 can be initiated via either the Automation Engine 50 or the User 51. The Trading Engine 52 checks the user's authority and if insufficient, it Denies Access 53. If the user is authorized, the Trading Engine checks the status of the Communication Medium 54, and if unavailable, sends a request to make it available 55. Once determined that it is available, the Trading Engine 56 acquires information from the broker and updates the order status and portfolio.

If the user initiated the trade engine, then it waits for the user to initiate trading 63. When the user initiates trading, or if the automation engine started the trading engine and indicated that trading should be performed, the trading engine acquires information from the investment advice system 57, and generates new orders 58 If the user initiated the trading engine, then the trading engine displays the orders to the user and waits for the user's selection 59. The trading engine then submits the orders to the online broker 60, and acquires information from the broker and updates the order status and the portfolio 61.

If the automation engine initiated the trading engine, then the trading engine terminates processing at this point. If the user initiated the trading engine, then the trading engine goes into a wait state 63. If the trading engine is still waiting when the refresh interval expires, then the trading engine performs a reface cycle 54, 55, 56, and 63. When the user requests termination, the trading engine terminates 62.

Databases and Data Tables

It will be known to those skilled in the art that any known database query and design language can be used to create the database including Oracle, Sybase, Microsoft SQL, MS Access, or any other database design software that utilizes the Standard Query Language standard. Also, the skilled artisan will be able to formulate each field in a database data table or index, and define the data types (e.g., for example, text, string, number, whole number, floating number, decimal, fraction, ratio, alias, character, or a combination of these data types) of a field or index as needed without undue experimentation.

Turning now to FIG. 5A the table MTUsersPwd 70 contains the user ID and password for the authorized users of the Automated Trading System. Table MTUsers 72 contains the rest of the information associated with the user ID. Table MTLog 71 contains a log of the messages generated by the Automated Trading System. Table TradingCountries 73 contains a list of the valid country codes and their names. Sectors 74 contain lists of the industry sector codes and their attributes. Table ComputerSettings 75 contains the settings for the current computer. The table Brokers 79 contains a list of broker codes and their names and countries. The table BrFunctions 78 contains a complete list of all of the functions needed to interface with an online brokerage system. The table TradingCalendar 77 contains a calendar of the valid days when a stock exchange is open for a given country. The table MTSymbols 76 contains an invariant and unique list of symbols by which stocks are known internally by the automated trading system. The table BrSymbols 80 contains a list of stock symbols for each broker and the associated automated trading system symbol. The table BrScripts 81 contains a list of scripts given by the broker for performing a given function. The table BrScriptSteps 82 contains a list of steps for each script. The table UserBrokers 83 contains a list of the brokers used by a given user as identified by related tables MTUsersPwd 70 and MTUsers 72. The table UserBrokerActualAc 84 contains a list of the account numbers used with each Broker ID for a user ID.

Turning now to FIG. 5B, the Table UserBrokerAccts 90 contains the information by which a user interfaces with their chosen online broker (e.g., login information for the broker, brokerage account number, etc.). The table TxTypes 91 contains a list of types of possible transactions with any broker. The table Currencies 92 contains a list of codes for world currencies. The table Units 93 contains a list of codes representing units of measure for orders. The table Orders 94 contains the orders generated by the trading engine to be placed with the broker, and the attributes of each before and after being placed. The table HoldingTypes 95 contains a list of the types of holdings. The table Holdings 96 contains a list of the securities currently held by the user, and represents the user'portfolio. The table TxHist 97 contains a historical list of transactions that occur with the broker.

The Graphical User Interfaces

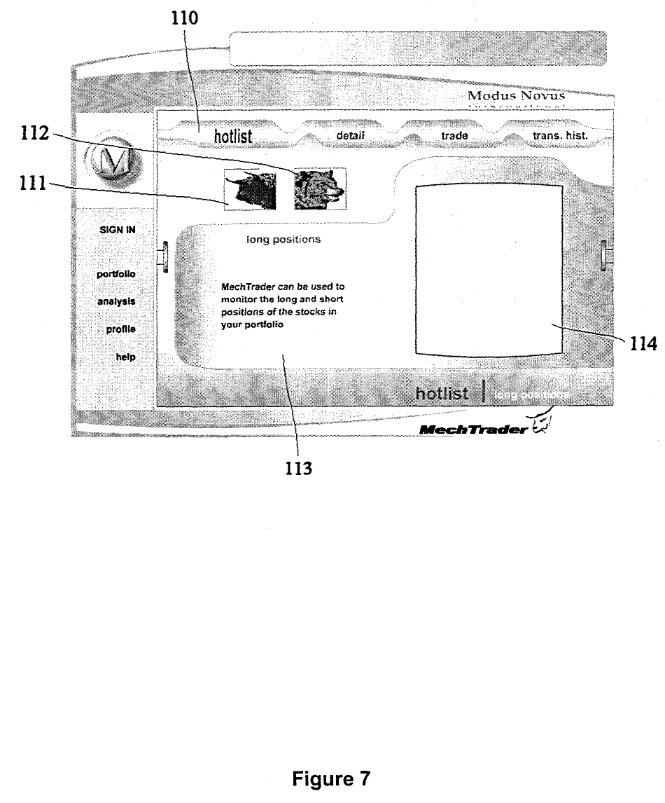

Turning now to FIG. 6, Vertical Menu Bar 100 contains the list of primary menu items that the user can select to direct the automated trading system in its functions. Login box 101 enables the user to enter an Automated Trading System user ID and password; login box 102 enables the user to enter their broker's user ID, password and pin, and then press Go button 104. The login boxes will be removed and their space plus interface area 103 is replaced with a new screen, shown in FIG. 7.

Turning now to FIG. 7, tab bar 110 appears with Hotlist highlighted. By pressing button 111, the description 113 and area 114 change to display the status of the user's long positions, respectively. The Hotlist is provided by the Investment Advice system and comprise preferred stocks for the trading day. By pressing button 112, the description 113 and area 114 change to display the status of the user's short positions. When the user presses Trade on tab bar 110, trade engine consults the user's broker information, the Investment Advice System and the user's portfolio, generates recommended orders, and the screen changes to that shown in FIG. 8.

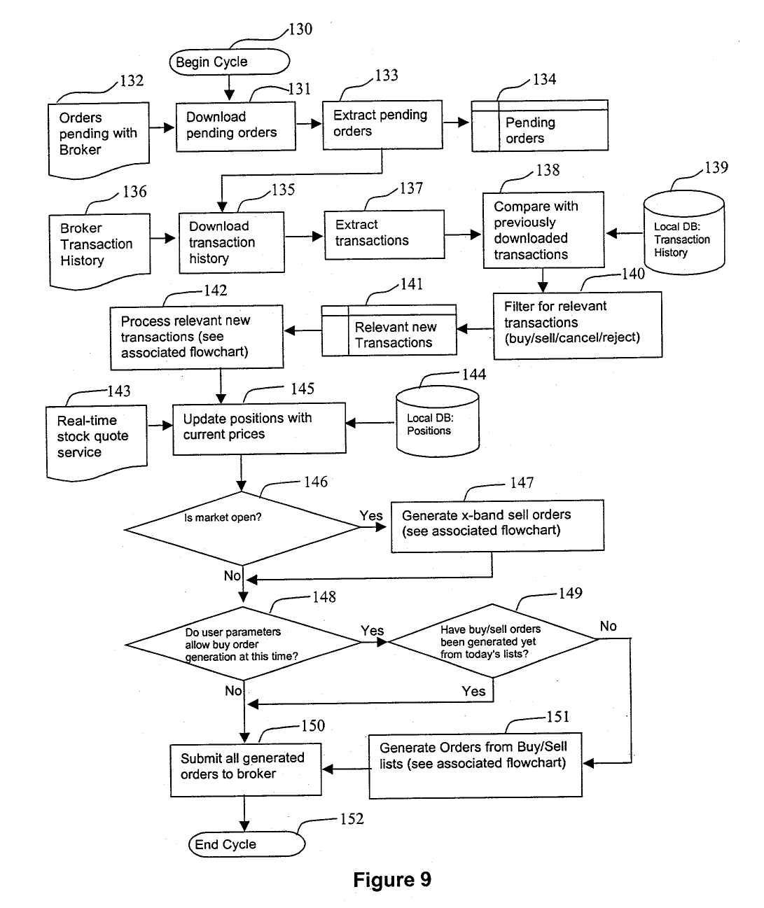

Turning now to FIG. 9, the recommended orders, as determined by analyzing the information obtained from the investment advice system, are shown in area 121. Tab bar 120 shows “Trade” highlighted. The user may click on an order to review it or view the details of an order, which appear in area 123. The user then presses the Go button on button bar 122, and the trade engine transmits the orders to the user's broker via the communication medium. As the transmission occurs, the status of the transmission is continuously shown in area 123. When order transmission is complete, the status indicates this in area 123.

The Trading Engine

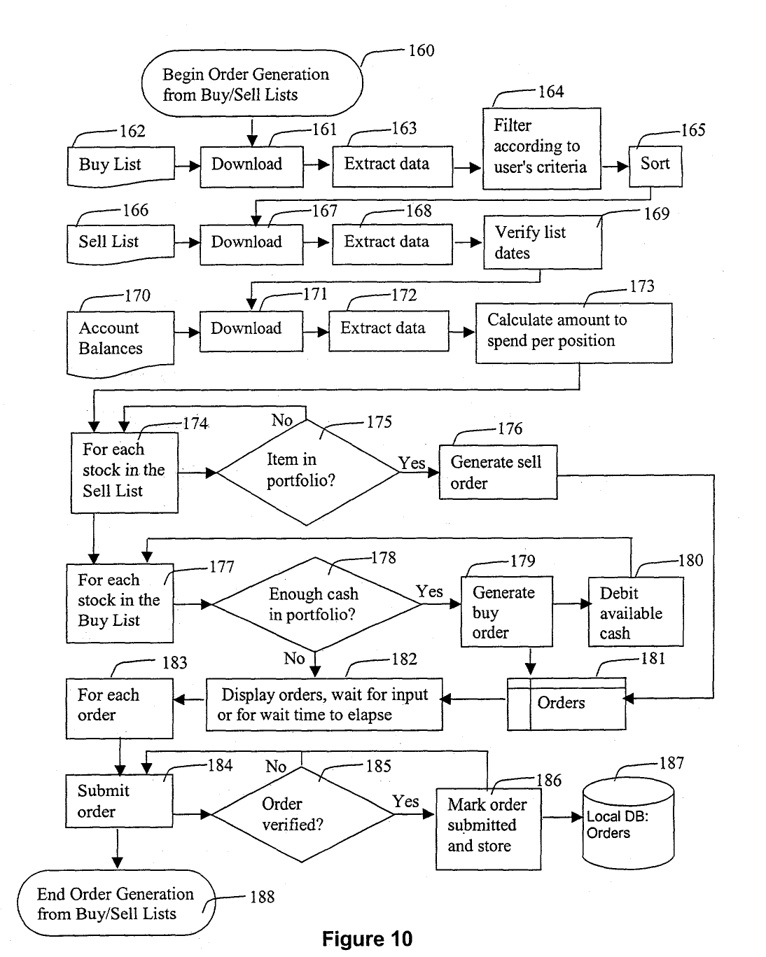

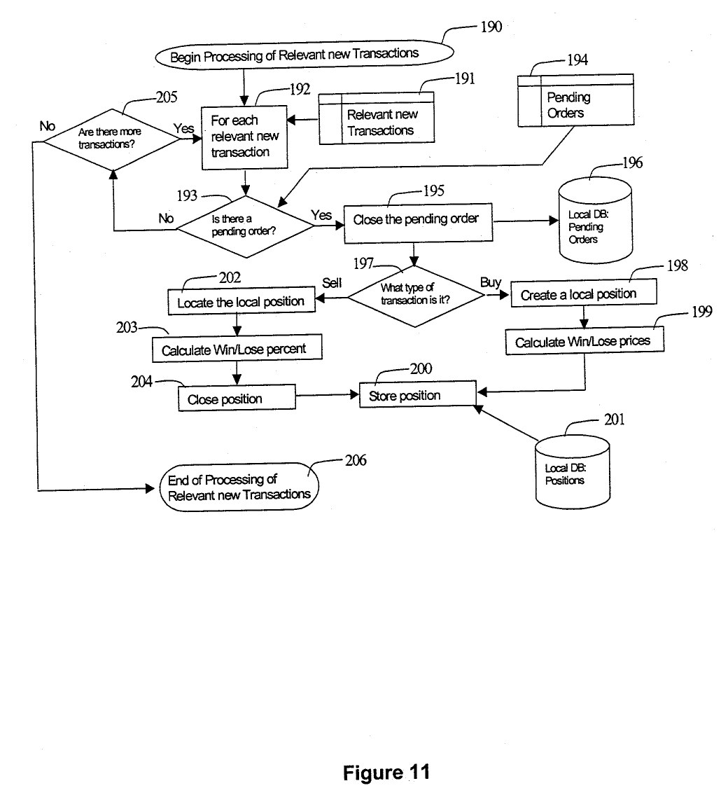

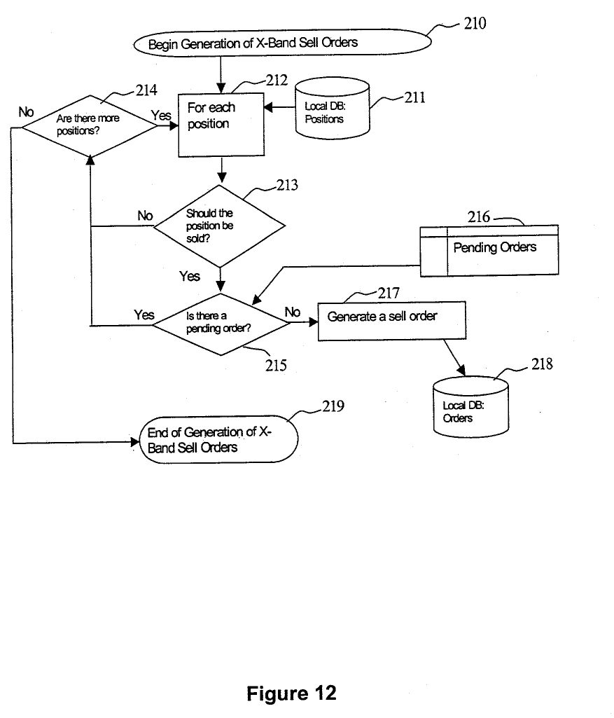

Referring to FIG. 9, the Trading Engine cycle 130 begins by downloading 131 via HTTP HTML (hypertext text transfer protocol hypertext markup language) documents containing orders that are pending at the broker 132, extracting the pending orders 133 by parsing the HTML and storing the pending orders 134 in a list in memory. The cycle continues by downloading 135 via HTTP and HTML documents containing the transaction history at the online brokerage system 136, extracting the transactions 137 by parsing the HTML and comparing previously downloaded transactions 138 stored in the local database transaction history table 139. When the new transactions are identified, they are filtered for relevancy 140 (only buy, sell, cancellation, and rejection transactions are relevant) and stored in memory 141. These new, relevant transactions are processed 142 on the associated flowchart in FIG. 11. The cycle continues by downloading quotes from a real-time stock quote service 143 via HTTP HTML documents, parsing them, and updating the current positions 144 with the current prices 145. A determination is made whether the market is open or not 146 using a market calendar in the database and if so, cross-band sell orders are generated 147 (see the associated flowchart in FIG. 12). The user parameters are consulted to determine if buy orders may be generated at this time 148, and if so, the determination is made as to whether buy/sell orders have already been generated for the current date 149. If not, buy/sell orders are generated from the buy/sell lists 151 (see the associated flowchart in FIG. 10).

Turning now to FIG. 10, the order generation from the buy/sell lists begins 160 by downloading 161 the buy list 162 via HTTP (HTTPS) as an HTML document and extracting the data 163 by parsing text from the HTML, and filtering the parsed data according to the user's criteria 164 specified on the splash screen (FIG. 13). An R₁ difference percentage is calculated for each item in the buy list according to the following formula:

(Resistance level 1−closing price)/closing price−100),

and the buy list is sorted 165 in descending sequence according to these numbers. The resistance level is the upper bound of an established trading range where the selling pressure from profit taking tends to cause the price of a stock to decline. In the present example, the resistance level is provided by the investment advice system. For example, the Internet website buysellorhold.com provides the resistance levels along with each of the stocks identified on its daily pick list. Other investment advice systems may calculate resistance levels using their own proprietary formulas.

The Sell List 166 is downloaded 167 via HTTP (or HTTPS) as an HTML document and the data is extracted 168 by parsing the HTML. The dates of both lists are verified 169 as the correct date. The account balances 170 at the broker are downloaded 171 via HTTP (or HTTPS) as an HTML document and extracted 172 by parsing the HTML. The amount to spend per position is calculated 173 by dividing the amount of cash available by the percent per position specified in the user's parameters.

For each stock in the Sell List 174, a determination is made whether the user currently holds that stock in the portfolio 175 and if so, a sell order is generated 176 and stored in memory 181.

For each stock in the Buy List 177, a determination is made as to whether enough cash exists in the portfolio 178 to purchase a position, and if so, a buy order is generated 179 and stored in memory 181 and the amount of available cash is debited 180 in memory.

When all orders possible have been generated 181, the orders are displayed to the user 182, waiting for the user to accept them or for the time-out interval to expire, at which time, each order accepted 183 is submitted to the broker 184 via HTTP (or HTTPS) by sending to the broker a URL with the appropriate form data appended. The HTML document sent back by the broker in response to the order form submission is parsed and the order submission is verified 185 and marked as submitted 186 and stored in the local database orders table 187. When all orders are submitted the order generation for the buy/sell lists ends 188.

Turning now to the FIG. 11, processing of relevant new transactions begins 190 by looping through the relevant new transactions 191. For each relevant new transaction, a determination is made whether there is a pending order 193 with the broker by looking in the in-memory pending orders table 194 downloaded from the broker (same also as 134 in FIG. 9, populated by 131, 132, 133 in FIG. 9.) If there is a pending order, it is closed 195 and stored in the local database orders table.

A determination is made 197 as to what type of transaction is being processed. If it is a buy transaction, a local position is created 198; the target, SoftStop and HardStop prices are calculated 199 and stored 200 in the local database positions table 201. The HardStop is a sell position at a predetermined price. The SoftStop is a sell position or sell order at the end of the trading day. A SoftStop may be calculated, for example, by

a) a fixed percentage of the open price, based on a user parameter. (e.g., if user specifies a SoftStop of 2%, and the stock opens at $50, then the SoftStop is set to $50×((100−2)/100)=$49),

b) the low price of previous day,

c) the blend (the higher of the two above numbers),

or the user may choose which method to apply.

The SoftStop is applied in the last 15 minutes of trading for the day. For example, if the SoftStop is $49, and the price of the stock dips below $49 between 3:45 and 3:59, then the position is sold at that time.

If it is a sell transaction, the local position is located 202, the amount gained/lost is calculated 203 and the position is closed 204 and stored 200.

This is repeated 205 until all relevant transactions are processed, at which point processing of relevant new transactions ends 206.

Turning now to FIG. 12, generation of cross-band (x-band) sell orders begins 210 by looping through the currently held positions in the local database positions table 211. For each position 212, a determination is made whether the position should be sold 213. Comparing the current stock price with the Target, SoftStop, and HardStop prices makes this determination. If the current price is greater than or equal to the Target price, or if the current price is less than or equal to the HardStop price, or if the time is between 3:45 and 3:49 PM and the current price is less than or equal to the SoftStop price, then the determination is made that the position should be sold. Otherwise, the next position is sought 214.

If the determination is made that the position be sold, a determination is made as to whether an order is currently pending at the broker 215 by consulting the pending orders table 216 (same as 134 in FIG. 9, populated by 131, 132, 133 in FIG. 9.)

If such an order is not pending with the broker, then a sell order is generated 217 and stored in the local database orders table 218.

This process is repeated 214 for the remaining positions until there are no more to process. This ends the generation of the cross-band (x-band) sell orders 219.

### EXAMPLE II

### An Exemplary Application of the Automated Trading System to an Investment Advice System

In an exemplary embodiment of the automated trading system, the automation engine downloads two lists on each morning of day trading. The lists are downloaded from the BuySellOrHold.com website, and are in the form of HTML documents. The lists are downloaded over the Internet via TCP/IP. The lists contain the following information in character format:

1) Buy or sell indicator,

2) Stock symbol,

3) Resistance levels 1 & 2 (in dollars and cents),

4) Support levels 1 & 2 (in dollars and cents),

5) Previous low price, and

6) Previous close price.

When the system starts up, a splash screen (FIG. 13) is shown whereby the user verifies or changes values for the following parameters:

1) buy switch (buy/don't buy new stocks),

2) open time of order generation window,

3) close time of order generation window,

4) absolute maximum dollars to invest,

5) maximum percent of capital to spend,

6) minimum buylist price,

7) minimum reversal day volume,

8) percent of portfolio per long position,

9) soft stop loss: (select one),

10) reversal day low,

11) fixed percent (fill in value),

12) blend (the higher of reversal day low or of fixed percent),

13) sell (used to calculate take-profit target price, choose one),

14) R₁/R₂,

15) fixed (fill in percent),

16) hard stop loss (percent),

17) checkbox: round lots to multiples of 10,

18) checkbox: auto-start, and

19) checkbox: trade any time.

Optimum Parameter Settings Using the Exemplary Embodiment

Optimum parameter settings for portfolios over $30,000, as determined via back-testing using year 2001 data:

1) order generation window open time: 9:00 am,

2) order generation window close time: 9:25 am,

3) minimum buylist price: 20.00,

4) minimum reversal day volume: 250,000,

5) % of portfolio per long position: 16%,

6) Hard Stop Loss: 50%,

7) soft stop loss Fixed 1.4%,

8) Sell Fixed: 5.5%,

9) enable Trade At Anytime,

10) enable Round Lots to 10s, and

11) enable auto-start.

Description of Exemplary Trading Parameters

The following parameters are taken into consideration when the system calculates and determines whether to trade. Investment advice acquired from an online investment advice system (e.g., BuySellOrHold.com) must additionally fall within the constraints set by the following parameters (e.g., ranges, upper and lower limits):

Trade at Anytime

Setting this parameter allows the automated trading system to generate buy orders when the market is closed. Preferably, this option is selected so that the system will only generate buy orders prior to market open and thus obtain near-open fill prices, taking advantage of the run-up in securities, which are appreciating.

Absolute Maximum Money to Invest

This is the absolute amount of investment capital that the system is allowed to spend. For example, if the account is worth $100,000 and a user sets this value to $50,000, then the system will only invest $50,000 and keep the rest in cash. If a user sets the value to $200,000, then the system will be allowed to allocate the entire $100,000 to investment purposes, but will be limited to investing $200,000 when the account exceeds that amount. A user may leave the value blank to specify no maximum.

When the system uses this value to calculate the total amount of cash available to purchase stocks and to calculate the amount of cash that can be allocated to any one stock purchase. If the setting number is too low it will not impact the functionality of the system. If this amount is set too high, the system will use the maximum available funds in the user's brokerage account. A user desiring that the full value of their account be used should leave this field blank.

To determine that the value has been set too high a user can check with the online brokerage site directly to determine the total liquidity value of their account. If users desire to limit the amount of funds available to the system the maximum amount to invest field should be set to a value at or below the liquidity amount.

If the value is set too low the system will limit the amount of money available to it and this could negatively impact the performance of the tool since the user will not be able to trade against the full value of their account.

One way a user can tell if the value has been set too low is if they are winning the majority of their trades but they experience relatively little to no growth in the overall value of their portfolio.

Maximum Percentage of Capital to Spend

This is the percentage of the total account value a user desires to make available to the trading system. If a user sets this value to 100% then the full value of the user's account will be used.

For example, if the overall cash value of a user's account is $100,000.00 and the user sets this value to 90 percent, the system will only spend up to $90,000.00.

The automated training system according to the invention uses this percentage just prior to issuing buy orders. The automated trading system uses this percentage to calculate the “actual” total account value to trade against.

If this percentage is set too high, then a user has put more money at risk than they may be comfortable with. If the setting is set too low it will limit the amount of money available to the system and could negatively impact the performance of the tool since the user will never be able to trade against the full value of their account.

If the user is winning the majority of their trades, and they are experiencing relatively little to no growth in the overall value of their portfolio, this value may be set too high.

Minimum Buy List Price

This indicates the minimum priced stock that a user is willing to purchase. For example, if the value is set at $10.00, and the stocks listed in the daily pick list were valued at $3.00, $8.00, $13.00, and $18.00 respectively, the automated trading system would only place orders for the stocks valued at $13.00 and $18.00. The automated trading system uses this value to filter stocks from a daily picks list generated by an advice source such as the BuySellorHold.com after acquiring the list. Setting this value too high will limit the number of stocks available for purchase.

If a user sets this value too high they may seldom (or never) make any purchases on trading days where a significant number of stocks appear in their daily pick list.

If a user sets this value too low it leaves them exposed to purchasing large amounts of bulletin board or penny stock many of which have very volatile and unpredictable trading patterns. If a user is almost always “fully invested,” and holds a significant number of penny stocks (e.g. stocks with the extension .OC) or stocks valued at or below $5.00, this value may have been set too low.

HardStop Loss

This is the maximum percentage loss a user is willing to take on a stock before trying to sell, or liquidate it. For example, once a stock's value falls to or below the hard stop-loss percentage, The automated trading system will attempt to immediately liquidate the position to prevent any significant or further losses. The automated trading system uses this percentage to calculate a hard stop-loss price based on the actual purchase price of a successful buy order. The system monitors a stock's price throughout the course of a trading day. Should the stock's price fall to or below a hard stop-loss price, the system will issue an immediate sell order.

If the percentage is set too high, a user may incur a greater degree of loss before a sell order is submitted that is beyond the acceptable loss limit.

Alternatively, if the percentage is set too low the user may inadvertently sell a position primed for a rebound before the end of the trading day. For example, if a user notices that the user sells positions at a loss before 3:45 pm, and these same positions rebound in price later in the trading day, the user may have set this value too low.

Minimum Daily Average Volume

This is the minimum average amount of shares of a stock that trades hands on a daily basis. For example, some stocks trade in low volumes, where only a few thousand shares are traded daily. Other stocks may trade at much higher daily volumes, where tens to hundreds of millions of shares are traded daily. The automated trading system uses this value to filter stocks after receiving the daily pick list generated by BuySellorHold.com.

If the value is set too high, the trading system will be significantly limited to the number of stocks available for purchase. If a user seldom (or never) makes any purchases on days where a significant number of stocks appear in the daily pick list, the value may be set too high.

Setting this value too low leaves a user exposed to purchasing stocks that may be difficult to later sell, or liquidate, at a predictable price. For example, if a user frequently notices significant delays in buying or selling stocks, or if a user frequently encounters buy and sell prices that are significantly different than the bid and ask prices of the item that the user tries to purchase or liquidate, the value may be set too low.

Percentage of Portfolio Per Long Position

This term means the percentage of the total account value used to purchase individual stocks. For example, if a user's total account value is $100,000.00, and the user enters 10 percent for this field, the system will attempt to spend $10,000.00 per purchase, and will purchase up to 10 stocks at a given time.

The automated trading system uses this value just prior to executing morning buy orders. The system multiplies this percentage and the total value of a user's account (which is the current, total liquidity value of the account) to determine the total amount to spend on each purchase.

If a user sets this value too high, the user will limit the amount of stocks that can be purchased (and held) at a given time. This, in effect, limits the short-term diversity of a user's portfolio. For example, if a user has spent all the available cash in their account, and they hold fewer than 5 stocks, then the value may be set too high.

If a user sets this value too low, they may never be able to get fully invested (i.e. the user won't have all of their money “working” for them). For example, if a user has not spent all of the available cash in a their account, and a user holds more than 20 stocks, the user may have set this value too low.

Round Lots to Multiples of 10

This value rounds lots, by multiples of 10.

For example, in a preferred embodiment, if the system determines that, based on the amount to spend per position, it should purchase 54 shares of a particular stock, and this user specified parameter is selected; the system will round the lot down to 50 shares. Alternatively, if instead 55 shares were calculated, it would round up to 60, provided enough cash is available, otherwise it would round down.

In the preferred embodiment system uses this selection to round off, to the nearest multiple of 10, the amount of shares it will purchase of a particular stock while generating the daily buy orders.

Winning Sell Blend

This option sets the winning sell price equal to either the fixed sell percentage or R₁, whichever is less. For example, in a preferred embodiment if the open price of a stock is $100.00 and the first resistance level (R₁) is $104.00, and if a user's specified fixed sell percentage is set at 5%, the system will use $104.00 as the target price.

Th system calculates this value during each cycle. It is first calculated when the stock is first purchased. If a user changes this parameter, a new target price will be calculated in the subsequent cycle.

The system monitors a stock's price throughout the course of the trading day. Should the stock's price rise above the target price, the system will generate a sell order at the time of day predicated by the options that control when sell orders are generated.

Winning Sell Fixed Percentage

This is the percentage profit a user wants to take from a winning trade. For example, if a user purchases a stock that opened at $100.00 per share, and a user sets this value to 5 percent, the system will issue an immediate sell order when the stock's price reaches or exceeds $105.00.

The system uses this percentage to calculate a winning sell price based on the open price of a successful buy order. The system monitors a stock's price throughout the course of the trading day. Should the stock's price hit or surpass the winning sell price, the system will issue an immediate sell order.

If a user sets this percentage too high, the user's stock may never reach the winning sell price. If a user can continue to hold stocks for periods of 10 or more trading days, or if a user notices that a large percentage of stocks gain more than 5 percent in value, but are never sold, a user may have set this value too high.

If a user sets this value too low, a user will limit the potential growth of their portfolio value. If a user is winning the majority of their trades, but the user's portfolio's value only shows marginal growth or no growth at all, the user may have set this value too low.

Winning Sell R₁/R₂

This option is selected if a user wants to trade at the dynamically adjusted first (R₁) or second (R₂) resistance price level as predicted by BuySellorHold.com, for example.

If the first resistance price level of a stock is predicted to be $50.00, and the stock's price reaches this value, the system will set the winning sell price to the value of R₂. If the stock hits or surpasses the R₂ value, the system will issue an immediate sell order. However, if the stock price should retreat back to R₁, the system will issue an immediate sell order as close to the R₁ price as possible.

The trading system uses the R₁/R₂ values to set a winning sell price after processing a successful buy order. The system uses the R₁/R₂ values to place winning sell orders, based on the stock's price fluctuation in relation to the price resistance levels predicted by BuySellorHold.com.

SoftStop Loss Blend

The parameter SoftStop Loss (also referred to as Loss Stop Blend) will set the losing sell price at a value based at either a fixed percentage (about 2%) or the first losing support level (S₁) predicted by an investment advice system, for example, BuySellorHold.com.

For example, if the open price of a stock is $100.00, and the first losing support level, S₁, is $92.00, and a user has specified 2% as the losing sell fixed percentage, the system will set the losing sell price to $98.00, the higher of 92 and 98.

The system uses this value to calculate a losing sell price based on the open price of a successful buy order. The system monitors a stock's price throughout the course of the trading day. Should the stock's price fall to or below the losing sell price during the final 15 minutes of trading, the system will issue a losing sell order at that time.

SoftStop Loss Fixed Percentage

This is the percentage loss (also known as Losing Sell Fixed Percentage), less commissions, that a user is willing to accept for a losing trade. For example, if the open price of a stock is $100.00 per share, and a user sets this value to 2%, the trading system will issue an immediate sell order when the stock's price falls to or below $98.00 during the final 15 minutes of trading. The system uses this percentage to calculate a losing sell price based on the open price of a successful buy order.

The trading system monitors a stock's price throughout the course of the trading day. Should the stock's price fall to or below the losing sell price during the final 15 minutes of trading, the system will issue a sell order immediately. If a user sets this percentage too high, a user will incur greater losses and limit the potential growth of their overall portfolio value.

If a user continues to hold positions for periods of 10 or more trading days, or if a user notices that a large percentage of losing positions are sold at a price significantly lower than 98 percent of the purchase price, the user may have set this value too high.

SoftStop Loss Previous Close Low

This parameter (also known as Losing Sell Previous Close Low) is set if a user wants to liquidate a losing position at or below the stock's low price of the previous day.

For example, if a stock's low price was $50.00 the day before it was purchased, the system will liquidate the held position when it falls to or below $50.00 during the final 15 minutes of trading.

The system uses this option to set the losing sell price based on the previous day's low after processing a successful buy order. The trading system monitors a stock's price throughout the course of the trading day. Should the stock's price fall to or below the previous day's low during the final 15 minutes of trading, the system will issue a sell order at that time.

While in the examples set forth herein describe a transaction involving the purchase and sale of a security, the system can also be modified to implement in short selling trading as well. Further, it is contemplated and within of the scope of the invention that the system can be modified to allow for put and call options.

The references cited above are all incorporated by reference herein, whether specifically incorporated or not.

Having now fully described this invention, it will be appreciated by those skilled in the art that the same can be performed within a wide range of equivalent parameters, concentrations, and conditions without departing from the spirit and scope of the invention and without undue experimentation.

What is claimed is:

1. An automated method for trading securities comprising the steps of:
(a) acquiring automatically investment advice information about a security from an investment advice system;
(b) determining automatically whether to trade said security based on said investment advice information;
(c) formulating automatically an order to trade said security in response to said determining step; and
(d) transmitting automatically a formulated order to a brokerage system.

2. The method of claim 1, repeating the above steps at predetermined intervals for a plurality of securities, wherein said time interval does not exceed about eight hours.

3. The method of claim 1, further comprising selecting trading parameters from a graphical user interface, and storing said trading parameters in a database.

4. The method of claim 3, further comprising the step of acquiring automatically trading parameters from a database and carrying out the determining step within the constraints set by said trading parameters.

5. The method of claim 4, wherein the trading parameters are selected from Trade at Anytime, Absolute Maximum Money To Invest, Maximum Percentage of Capital to Spend, Minimum Buy List Price, HardStop Loss, Minimum Daily Average Volume, Percentage of Portfolio Per Long Position, Round Lots to Multiples of 10, Winning Sell Blend, Winning Sell Fixed Percentage, Winning Sell R₁/R₂, SoftStop Loss Blend, SoftStop Loss Fixed Percentage, or SoftStop Loss Previous Close Low.

6. The method of claim 1, further comprising querying the brokerage system automatically at predetermined time intervals to determine the status of the order from the transmitting step.

7. The method of claim 1, further comprising receiving automatically confirmation of a completed trade from said brokerage system after the transmitting step.

8. The method of claim 1, further comprising updating automatically a user's information based upon a trade completed by the transmitting step, wherein said user's information is selected from securities holdings, invested capital, available capital, or total capital.

9. The method of claim 6, further comprising repeating the formulating and transmitting steps in the event that the querying step determines that said order failed or the brokerage system returns an error.

10. The method of claim 1, wherein the determining is whether to buy or to sell said security.

11. An automated securities trading system comprising:
(a) means for acquiring automatically investment advice information about a security from an investment advice system;
(b) means for determining automatically whether to trade said security based on said investment advice information;
(c) means for formulating automatically an order to trade said security; and
(d) means for transmitting automatically a formulated order to a brokerage system.

12. The system of claim 11, further comprising means for selecting trading parameters from a graphical user interface, and means for storing said trading parameters in a database.

13. The system of claim 11, further comprising means for acquiring trading parameters from a database and means for determining within the constraints set by said trading parameters whether said security should be traded.

14. The system of claim 11, further comprising means for querying the brokerage system automatically at predetermined time intervals to determine the status of the order.

15. The system of claim 11, further comprising means for receiving confirmation of a completed trade from said brokerage system.

16. The system of claim 11, further comprising means for updating a user's information based upon a completed trade.

17. The system of claim 11, further comprising means for repeating the formulating of an order.

18. An automated securities trading system comprising:
(a) a user information database, wherein said user information database comprises user login information, automation preferences, user securities holdings information, user invested capital information, user available capital information, user total capital information, and user specified trading parameters,
(b) at least one graphical user interface,
(c) an investment advice system,
(d) a brokerage system, and
(e) a processor operative to acquire investment advice information about a security from an investment advice system via a computerized communications medium, determine whether to trade said security based on said investment advice information and information related to actual market conditions regarding said security, formulate an order to trade said security, and transmit a formulated order to said brokerage system via a computerized communication medium.

19. The system of claim 18, wherein said processor is further operative to acquire trading parameters from a database and determine whether to trade said security within the constraints set by said trading parameters.

20. The system of claim 18, wherein said processor is further operative to query the brokerage system automatically at predetermined time intervals to determine the status of a transmitted order.

21. The system of claim 18, wherein said processor is further operative to receive confirmation of a completed trade from said brokerage system.

22. The system of claim 18, wherein said processor is further operative to update a user's information based upon a completed trade.

23. The system of claim 20, wherein said processor is further operative to repeat the formulation of an order and the transmission of a formulated order in the event said query determines that said transmitting order failed or the brokerage system returns an error.

24. A computer program product comprising a computer readable storage medium, said computer readable storage medium comprising logic for enabling a processor to carry out the method of claim 1.

25. The computer program product of claim 24, further comprising logic for enabling a processor to carry out the method of claim 2.

26. The computer program product of claim 24, further comprising logic for enabling a processor to carry out the method of claim 3.

27. The computer program product of claim 24, further comprising logic for enabling a processor to carry out the method of claim 4.

28. The computer program product of claim 24, further comprising logic for enabling a processor to carry out the method of claim 5.

29. The computer program product of claim 24, further comprising logic for enabling a processor to carry out the method of claim 6.

30. The computer program product of claim 24, further comprising logic for enabling a processor to carry out the method of claim 7.

31. The computer program product of claim 24, further comprising logic for enabling a processor to carry out the method of claim 8.

32. The computer program product of claim 24, further comprising logic for enabling a processor to carry out the method of claim 9.

33. The computer program product of claim 24, further comprising logic for enabling a processor to carry out the method of claim 10.
